(19) United States
(12) Patent Application Publication
(10) Pub. No.: US 2008/0135321 A1
(43) Pub. Date: Jun. 12, 2008

(54) Personal mobility device with an incorporated safety and informational system

(76) Inventors: Richard A. Ripple, Westfield, IN (US); Clinton W. Erickson, Russiaville, IN (US)

Correspondence Address: DELPHI TECHNOLOGIES, INC., M/C 480-410-202, PO BOX 5052, TROY, MI, 48007, US

(21) Appl. No.: 11/636,007

(22) Filed: Dec. 8, 2006

(51) Int. Cl. A61G 5/04

(52) U.S. Cl. 180/282; 340/573.1

(57) ABSTRACT

A personal mobility device, such as a wheelchair or a scooter, is disclosed. The personal mobility device includes at least one angle sensor to detect if the personal mobility device has overturned, and at least one accelerometer to detect if the personal mobility device has been struck in an accident. The angle sensor and the accelerometer sensor or coupled to a processor, and transmit data to the processor. A communication module is coupled to the processor and automatically signals a remote party for assistance when activated by the processor in response to an indication that the personal mobility device has overturned or been struck. The personal mobility device further includes a mast having a video device mounted atop thereof and in communication with a display to provide a video signal from an elevated position to the display, and a current sensor and a remote battery disconnect switch to reduce the potential for electrical fire.

### BACKGROUND OF THE INVENTION

1. Field of the Invention

The subject invention relates to a personal mobility device for individually transporting a handicapped person, and a method of providing assistance to the handicapped person utilizing the personal mobility device.

2. Description of the Prior Art

Handicapped persons often rely on a personal mobility device, such as a wheel chair or scooter, for their personal transportation. These handicapped persons, especially when severely handicapped, have had to rely upon the close proximity of others for assistance in emergency situations. Accordingly, some personal mobility devices have incorporated several different features for alerting others for assistance, thereby providing a level of independence and freedom to the handicapped person that was previously not available.

U.S. Pat. No. 6,154,690 (the '690 patent) issued to Coleman discloses a multi-featured automated wheelchair. The wheelchair includes three separate controllers optionally used for transmitting emergency data, activating an alarm system, and adjusting a seat position. A computer, having an input device such as a keyboard, is operatively connected and mounted to the wheelchair. An alarm is attached to the wheelchair to request assistance when activated by the handicapped person.

Wheelchairs, such as disclosed in the '690 patent, provide the handicapped individual with a certain level of freedom by alleviating some of the dependence on nearby persons. However, the alarms disclosed in the '690 patent are only activatable by the handicapped individual. Accordingly, in the event of an emergency in which the handicapped individual is unable to operate the alarm, the handicapped individual must still rely on others for assistance. This often limits the handicapped individual's sense of freedom, as the handicapped individual is less likely to venture to remote locations where no one is present to assist them in the event of an emergency.

### SUMMARY OF THE INVENTION AND ADVANTAGES

The subject invention provides a personal mobility device for individually transporting a handicapped person. The personal mobility device comprises a frame, and at least one angle sensor for sensing an orientation of the frame relative to a pre-determined plane. A processing unit is in communication with the at least one angle sensor, and receives data from the at least one angle sensor representing the orientation of the frame. The processing unit includes a communication module that is automatically activated in response to the orientation of the frame being outside a predetermined range relative to the pre-determined plane. The communication module, once activated, alerts a remote party for assistance.

The subject invention also provides a method of providing assistance to a handicapped person utilizing the personal mobility device. The method comprises the steps of setting a pre-determined range of acceptable orientations of the personnel mobility device relative to a pre-determined plane; sensing the orientation of the personal mobility device relative to the pre-determined plane; and alerting a remote party to provide assistance to the handicapped person automatically when the personal mobility device is outside the pre-determined range of acceptable orientations.

Accordingly, the subject invention provides a personal mobility device, such as a wheelchair or a scooter, that will automatically alert a remote party for assistance regardless of the ability of the handicapped individual to signal for help, i.e., the personal mobility device will signal for help when the handicapped individual is unconscious or otherwise unable to signal for help. The subject invention therefore provides a level of freedom not before available by permitting the handicapped person to venture into locations the handicapped person would otherwise not travel before for fear of an emergency situation in which the handicapped person is unable to signal for help.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of a personal mobility device having several safety and entertainment features incorporated therein; and

FIG. 2 is a sample snapshot of a display attached to the personal mobility device.

### DETAILED DESCRIPTION OF THE INVENTION

Referring to the Figures, wherein like numerals indicate corresponding parts throughout the several views, a personal mobility device is shown generally at 20. The personal mobility device 20 individually transports a handicapped person, and is typically a wheelchair, as is shown in the drawings, or a personal scooter. It should be understood that the personal mobility device 20 may also include some other device capable of transporting a handicapped person and still fall within the scope of the claims.

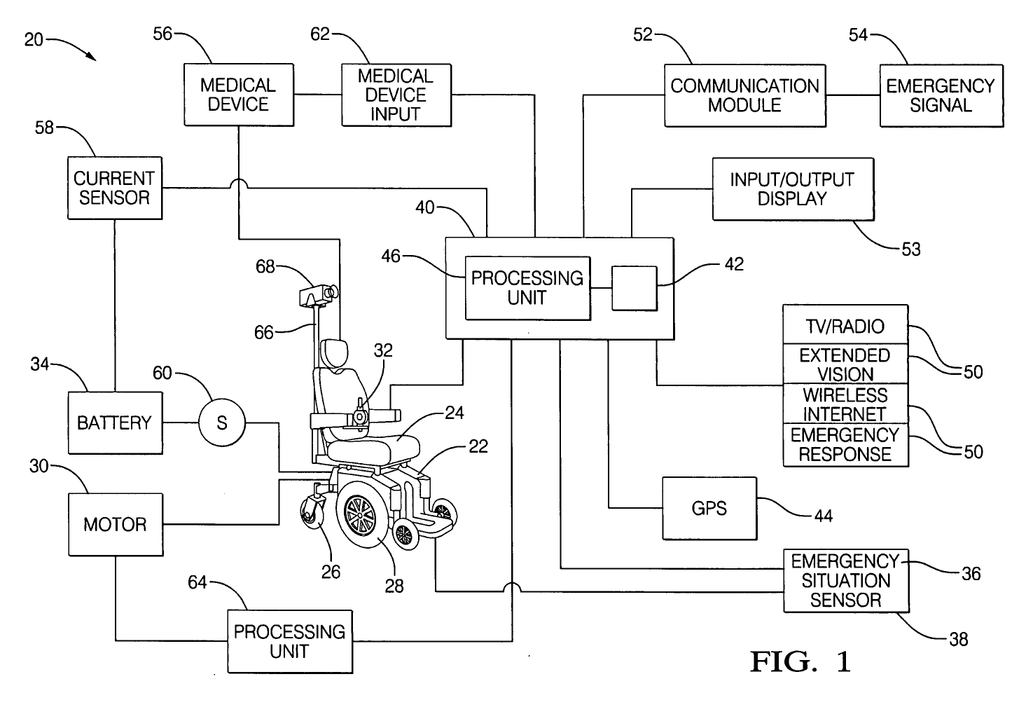

Referring to FIG. 1, the personal mobility device 20 includes a frame 22, which supports a chair 24. At least one pivotable wheel 26, but preferably a pair of pivotable wheels 26, is rotatably mounted to the frame 22 for rotation about a first horizontal axis and pivotable about a vertical axis. A pair of non-pivotable wheels 28 is rotatably mounted to the frame 22 for rotation about a second horizontal axis. A motor 30 is coupled to the pair of non-pivotable wheels 28 for driving the pair of non-pivotable wheels 28. A control mechanism 32 is coupled to the pair of non-pivotable wheels 28 and the motor 30 for controlling a speed and a direction of the personal mobility device 20 as is known in the art. The motor 30 is powered by a primary battery 34 coupled thereto.

At least one angle sensor 36, but preferably a plurality of angle sensors 36, is attached to the frame 22. The angle sensor 36 senses an orientation of the frame 22 relative to a pre-determined plane. The pre-determined plane is typically a level plane parallel with a ground surface. The angle sensor 36 senses the orientation of the frame 22 relative to the pre-determined plane to determine if the frame 22 and thereby the personal mobility device 20 has over-turned, which would indicate an emergency situation for the handicapped person.

At least one accelerometer sensor 38 is also attached to the frame 22. The accelerometer sensor 38 senses a sudden change in speed of the frame 22 and thereby the personal mobility device 20, which would be an indication of a collision event, i.e., an indication that the personal mobility device 20 had been in an accident or struck by another vehicle. A collision event is also considered an emergency situation for the handicapped person.

The personal mobility device 20 further includes a processing unit 40 attached to the frame 22 and in communication with the angle sensor 36 and the accelerometer sensor 38. The processing unit 40 receives the data from the angle sensor 36 representing the orientation of the frame 22 and from the accelerometer representing the acceleration of the frame 22. The processing unit 40 is typically a lap-top computer mounted to the frame 22 of the personal mobility device 20. However, it should be understood that the processor unit could be some other type of computer, and may be integral with the personal mobility device 20. The processing unit 40 is coupled to the primary battery 34 to power the processing unit 40 during normal operating conditions. Additionally, the processing unit 40 may also include an internal backup battery 42 in the event the primary battery 34 fails. Accordingly, if the primary battery 34 fails, the internal backup battery 42 permits the processing unit 40 to continue operations and allow the handicapped person to signal for assistance.

The processing unit 40 includes a global positioning satellite receiver 44 for determining a current location of the device. The global positioning satellite receiver 44 operates as is known in the art by communicating with several different satellites to triangulate the position of the receiver 44, thereby determining the position of the personal mobility device 20 and the handicapped person. Accordingly, the handicapped person, and anyone in communication with the handicapped person or the personal mobility device 20 is capable of determining the exact location of the personal mobility device 20 at all times. Additional functionality may be added to the personal mobility device 20 by incorporating an electronic compass and access to directional information through the internet as described below. to obtain real-time directions to desired locations.

Preferably, the processing unit 40 includes a modular mainframe computer 46, which includes a plurality of slots 48 for individually receiving a card 50. Each of the cards 50 provides additional functionality to the processing unit 40. The different cards 50 may include one or more cards 50 chosen from a group of cards 50 comprising an extended vision card 50, an emergency response card 50, a television/radio card 50, and a wireless internet card 50. Other cards 50 providing other functionality may also be included in the group of cards 50 and incorporated into the personal mobility device 20 to add further functionality to the personal mobility device 20.

The processing unit 40 further includes a communication module 52, which is automatically activated by the processing unit 40 in response to the orientation of the frame 22 being outside a predetermined range relative to the pre-determined plane or in response to a sensed sudden accelleration of the frame 22. The communication module 52 alerts a remote party for assistance when activated. The pre-determined range is an allowable range in which the frame 22 may be oriented relative to the pre-determined plane that does not indicate an emergency situation for the handicapped person, i.e., a safe operating range. A measurement outside the pre-determined range indicates that the personal mobility device 20 has overturned and is considered an emergency situation.

The communication module 52 includes a cellular connection to permit the processing unit 40 to communicate with the remote party. The cellular connection may include a cellular phone or a satellite phone that provides access to a nation wide network. The cellular connection permits the handicapped person to make personal phone calls from the personal mobility device 20 as well. It should be understood that the cellular connection may also include some other type of communication technology that permits the remote communications without a hardwire connection.

An input-output display 53 is coupled to the processing unit 40 for entering commands into the processing unit 40 and displaying data to the handicapped person. The input-output display 53 is preferably a LCD touch screen display, or some other similar display capable of displaying images to the handicapped person and inputting data or commands to the processing unit 40.

The personal mobility device 20 further comprises an emergency signal 54 coupled to the communication module 52. The emergency signal 54 is manually activated by the handicapped person to activate the communication module 52 to alert the remote party for assistance. The emergency signal 54 may be a button attached to the personal mobility device 20, or a command entered into the input-output display 53.

If necessary, depending on the specific type of disability of the handicapped person, the personal mobility device 20 may further include an auxiliary input in communication with the processing unit 40. The auxiliary input is an alternative method of entering commands into the processing unit 40. The auxiliary input may include an input chosen from a group of inputs comprising a sip blow input, a joystick input, a voice activation input, a head mounted pointing input, a push button input, and a specialized keyboard input. It should be understood that the auxiliary input may include other types of input devices other than specifically enumerated above.

The ability to perform self-diagnostic tests and remotely transmit these diagnostic tests to a home information center, the remote party, or the manufacture of the personal mobility device 20 would significantly enhance the safety of the personal mobility device 20. Accordingly, if the processing unit 40 is equipped with the emergency response card 50, then the personal mobility device 20 may further comprise at least one current sensor 58 in communication with the processing unit 40 for transmitting data to the processing unit 40 to indicate a malfunction in the battery. A switch 60 is in communication with and controlled by the processing unit 40 for automatically disconnecting the battery upon receiving an indication of a malfunction in the battery from the current sensor 58. Accordingly, the current sensor 58 monitors for an over-current event, and if one is detected, the processing unit 40 activates the switch 60 to disconnect the battery before an electrical fire occurs on the personal mobility device 20.

Additionally, when the processing unit 40 is equipped with the emergency response card 50, the personal mobility device 20 may include a medical device 56 attached to the frame 22. The medical device 56 may include a respirator, heart rate monitor, blood pressure monitor, or some other medical device 56 for monitoring the health of the handicapped person. In such a case, the personal mobility device 20 may also include a medical device sensor 62 in communication with the processing unit 40 for transmitting data to the processing unit 40. The medical device sensor 62 monitors the medical device 56 to indicate a medical emergency with the handicapped person and automatically activate the communication module 52 to alert the remote party for assistance. Additionally, the medical device sensor 62 may monitor the operation of the medical device 56 as well, and automatically activate the communication module 52 to alert the remote party that the medical device 56 had failed and that the handicapped person is in need of assistance.

The emergency response card 50 may also allow the personal mobility device 20 to further comprise at least one component sensor 64 in communication with the processing unit 40 for transmitting data to the processing unit 40. The component sensor 64 may include a motor sensor to indicate a malfunction in the motor 30. It should be understood that the component sensor 64 may include a sensor for monitoring any component of the personal mobility device 20, and is not limited to the motor sensor.

If the processing unit 40 is equipped with the extended vision card 50, the personal mobility device 20 further comprises a telescoping mast 66 attached to the frame 22. A video apparatus 68 is disposed on top of the telescoping mast 66 in communication with the processing unit 40 for providing a video signal to the input-output display 53 through the processing unit 40.

If the processing unit 40 is equipped with either the television radio card 50 or the wireless internet card 50, then the processing unit 40 will display a television program through the input-output display 53, broadcast a radio program through the input-output device, or allow the handicapped person to connect to the internet through the input-output display 53 respectively. Accordingly the television radio card 50 and the wireless internet card 50 add entertainment capabilities to the personal mobility device 20.

The subject invention also provides a method of providing assistance to a handicapped person utilizing the personal mobility device 20. The method comprises the steps of setting a pre-determined range of acceptable orientations of the personnel mobility device relative to a pre-determined plane. As described above, the range of pre-determined orientations of the personal mobility device 20 indicate and allowable operating range in which there is no indication of an overturn occurrence. The pre-determined range will be dependent upon the specific design and geometric properties of the personal mobility device 20.

The method further comprises the step of sensing the orientation of the personal mobility device 20 relative to the pre-determined plane. The orientation of the frame 22, and thereby the personal mobility device 20, is sensed by the angle sensor 36 attached to the frame 22 of the personal mobility device 20 as described above.

The method further comprises the step of sensing the acceleration of the personal mobility device 20, i.e., monitoring the accelerometer sensor 38 to detect a sudden acceleration of the personal mobility device 20 to indicate a collision event involving the personal mobility device 20.

The method further comprises the step of locating the personal mobility device 20. The personal mobility device 20 is located by the global positioning satellite receiver 44 as described above. After the personal mobility device 20 is located, the remote party is alerted by the communications module to provide assistance to the handicapped person automatically when the personal mobility device 20 is outside the pre-determined range of acceptable orientations or when the personal mobility device 20 has suddenly accelerated indicating a collision event involving the personal mobility device 20. The location of the personal mobility device 20 is then communicated to the remote party, if necessary.

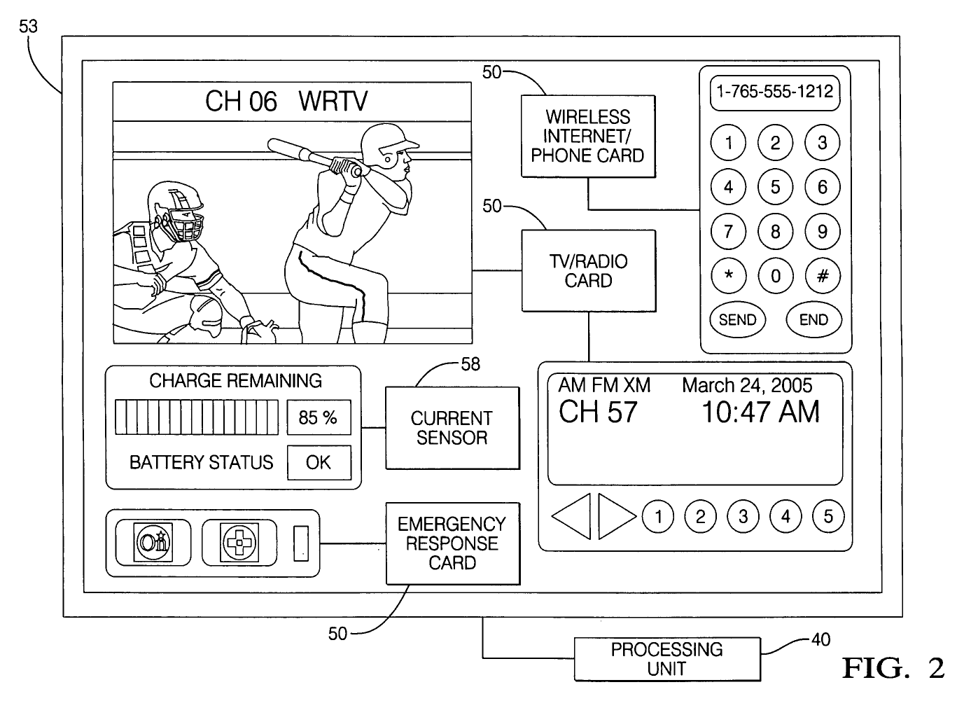

As shown in FIG. 2, the method further comprises the step of communicating with the handicapped person through the input-output display 53. The remote party may communicate with the handicapped person before or after notifying emergency personnel to verify if assistance is necessary. Alternatively, if alerted by the communication device, the remote party may notify emergency personnel with or without communicating with the handicapped person.

The method further comprises the step monitoring the current sensor 58 to detect a malfunction in the battery. If a malfunction in the battery is detected, the method further comprises the step of activating the switch 60 to disconnect the battery. Once the switch 60 has been activated, the method further comprises the step of alerting the remote party to provide assistance to the handicapped person automatically upon detection of a malfunction in the battery.

The method further comprises the step of monitoring the medical device sensor 62 to detect a medical emergency with the handicapped person. If a medical emergency with the handicapped person is detected, the remote party is alerted to provide assistance to the handicapped person automatically upon detection of a medical emergency with the handicapped person.

The method further comprises the step of monitoring the component sensor 64 to detect a malfunction in the motor 30. If a malfunction is detected with the motor 30, the method further comprises the step of displaying a message on the input-output display 53 to indicate a malfunction with the motor 30 to the handicapped person. The method further comprises the step of alerting the remote party to provide assistance to the handicapped person automatically upon detection of a malfunction with the motor 30.

The method further comprises the step of displaying a video to the handicapped person from the video apparatus 68 to provide the handicapped person with an elevated view of a surrounding environment.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A personal mobility device for individually transporting a handicapped person, said device comprising:
a frame;
at least one angle sensor for sensing an orientation of said frame relative to a pre-determined plane;
a processing unit in communication with said at least one angle sensor for receiving data from said at least one angle sensor representing the orientation of said frame;
said device characterized by said processing unit including a communication module automatically activatable in response to the orientation of said frame being outside a predetermined range relative to the pre-determined plane for alerting a remote party for assistance.

2. A device as set forth in claim 1 further comprising at least one accelerometer sensor in communication with said processing unit for transmitting data to said processing unit to indicate a collision and automatically activate said communication module to alert the remote party for assistance.

3. A device as set forth in claim 1 wherein said processing unit includes a global positioning satellite receiver for determining a current location of said device.

4. A device as set forth in claim 3 wherein said communication module includes a cellular connection.

5. A device as set forth in claim 1 wherein said personal mobility device further comprises:
a chair supported by said frame;
at least one pivotable wheel rotatably mounted to said frame for rotation about a first horizontal axis and pivotable about a vertical axis;
a pair of non-pivotable wheels rotatably mounted to said frame for rotation about a second horizontal axis;
a motor coupled to said pair of non-pivotable wheels for driving said pair of non-pivotable wheels; and
a control mechanism coupled to said pair of non-pivotable wheels for controlling a speed and a direction of said device.

6. A device as set forth in claim 1 further comprising an input-output display coupled to said processing unit for entering commands into said processing unit and displaying data to the handicapped person.

7. A device as set forth in claim 5 further comprising a battery for powering said motor and said processing unit.

8. A device as set forth in claim 7 wherein said processing unit includes an internal backup battery.

9. A device as set forth in claim 1 further including an auxiliary input in communication with said processing unit for entering commands into said processing unit.

10. A device as set forth in claim 9 wherein said auxiliary input includes one of a group comprising a sip blow input, a joystick input, a voice activation input, a head mounted pointing input, a push button input, and a specialized keyboard input.

11. A device as set forth in claim 1 further comprising an emergency signal coupled to said communication module for manually activating said communication module to alert the remote party for assistance.

12. A device as set forth in claim 1 wherein said processing unit includes a modular mainframe computer including a plurality of slots for individually receiving a card providing additional functionality to said processing unit.

13. A device as set forth in claim 12 wherein said card includes one of a group comprising an extended vision card, an emergency response card, a television/radio card, and a wireless internet card.

14. A device as set forth in claim 13 further comprising a battery for powering said motor and said processing unit and at least one current sensor in communication with said processing unit for transmitting data to said processing unit to indicate a malfunction in said battery.

15. A device as set forth in claim 14 further comprising a switch in communication with and controlled by said processing unit for automatically disconnecting said battery upon receiving an indication of a malfunction in said battery from said current sensor.

16. A device as set forth in claim 13 further comprising a medical device attached to said frame and a medical device sensor in communication with said processing unit for transmitting data to said processing unit to monitor said medical device to indicate a medical emergency with the handicapped person and automatically activate said communication module to alert the remote party for assistance.

17. A device as set forth in claim 13 further comprising a motor coupled to said frame and at least one component sensor in communication with said processing unit for transmitting data to said processing unit to indicate a malfunction in said motor.

18. A device as set forth in claim 13 further comprising an input-output display coupled to said processing unit and a telescoping mast attached to said frame having a video apparatus disposed on top of said telescoping mast in communication with said processing unit for providing a video signal to said input-output display through said processing unit.

19. A method of providing assistance to a handicapped person utilizing a personal mobility device, said method comprising the steps of:
setting a pre-determined range of acceptable orientations of the personnel mobility device relative to a pre-determined plane;
sensing the orientation of the personal mobility device relative to the pre-determined plane;
said method characterized by alerting a remote party to provide assistance to the handicapped person automatically when the personal mobility device is outside the pre-determined range of acceptable orientations.

20. A method as set forth in claim 19 wherein the personal mobility device includes a global positioning satellite receiver and the method further comprises the step of locating the personal mobility device by the global positioning satellite receiver.

21. A method as set forth in claim 20 further comprising the step of communicating the location of the personal mobility device to the remote party.

22. A method as set forth in claim 19 wherein the personal mobility device includes an input-output display and the method further comprises the step of communicating with the handicapped person through the input-output display.

23. A method as set forth in claim 19 wherein the personal mobility device includes a battery and a current sensor and the method further comprises the step monitoring the current sensor to detect a malfunction in the battery.

24. A method as set forth in claim 23 wherein the personal mobility device includes a switch and the method further comprises the step of activating the switch to disconnect the battery.

25. A method as set forth in claim 23 further comprising the step of alerting the remote party to provide assistance to the handicapped person automatically upon detection of a malfunction in the battery.

26. A method as set forth in claim 19 wherein the personal mobility device includes an accelerometer sensor and the method further comprises the step of monitoring the accelerometer sensor to detect a collision involving the personal mobility device.

27. A method as set forth in claim 26 further comprising the step of alerting the remote party to provide assistance to the handicapped individual automatically upon detection of a collision involving the personal mobility device.

28. A method as set forth in claim 19 wherein the personal mobility device includes a medical device and a medical device sensor and the method further comprises the step of monitoring the medical device sensor to detect a medical emergency with the handicapped person.

29. A method as set forth in claim 28 further comprising the step of alerting the remote party to provide assistance to the handicapped person automatically upon detection of a medical emergency with the handicapped person.

30. A method as set forth in claim 19 wherein the personal mobility device includes a motor and a component sensor and the method further comprises the step of monitoring the component sensor to detect a malfunction in the motor.

31. A method as set forth in claim 30 further comprising the step of displaying a message to indicate a malfunction with the motor to the handicapped person.

32. A method as set forth in claim 30 further comprising the step of alerting the remote party to provide assistance to the handicapped person automatically upon detection of a malfunction with the motor.

33. A method as set forth in claim 19 wherein the personal mobility device includes an elevated mast and a video apparatus disposed on top of the elevated mast and the method further comprises the step of displaying a video to the handicapped person from the video apparatus to provide the handicapped individual with an elevated view of a surrounding environment.
